(19) United States
(12) Patent Application Publication
(10) Pub. No.: US 2021/0114003 A1
(43) Pub. Date: Apr. 22, 2021

(54) TREATED IRON ORE CATALYSTS FOR PRODUCTION OF HYDROGEN AND GRAPHENE

(71) Applicant: King Abdullah University of Science and Technology, Thuwal (SA)

(72) Inventors: Jean Marie BASSET, Thuwal (SA); Lu ZHOU, Thuwal (SA); Linga Reddy ENAKONDA, Thuwal (SA)

(21) Appl. No.: 16/604,625

(22) PCT Filed: Apr. 13, 2018
(86) PCT No.: PCT/IB2018/052593

§ 371 Date: Oct. 11, 2019

Related U.S. Application Data
(60) Provisional application No. 62/485,461, filed on Apr. 14, 2017.

(51) Int. Cl. B01J 23/889; B01J 37/00; B01J 37/18; B01J 37/04; B01J 37/08; C01B 3/26; C01B 32/186

(52) U.S. Cl. CPC B01J 23/8892; B01J 37/0036; B01J 37/18; B01J 37/04; C01B 2203/1047; C01B 3/26; C01B 32/186; C01B 2203/0277; C01B 2203/1241; B01J 37/08

(57) ABSTRACT

Embodiments of the present disclosure describe a treated iron ore catalyst. Embodiments of the present disclosure further describe a method of preparing a treated iron ore catalyst comprising dehydrating an iron ore, milling the iron ore to a selected particle size, and reducing the iron ore to form a treated iron ore catalyst. Another embodiment of the present disclosure is a method of using a treated iron ore catalyst comprising contacting a feed gas with a treated iron ore catalyst to produce hydrogen and graphene.

### BACKGROUND

The most common graphene synthesis approaches known to date include mechanical exfoliation from graphite, chemical vapor deposition, and reduction of graphene oxide through heating; additional synthesis approaches have also been disclosed, e.g. carbon nanotube slicing, carbon dioxide reduction, spin coating of carbon nanotube, supersonic spray, intercalation, laser methods, microwave-assisted oxidation, ion implantation. Graphene is more than one hundred times stronger than the strongest steel; it conducts heat and electricity very efficiently and it is nearly transparent. These superior properties justify its increasing worldwide demand, for example for the electronic industry as well as in other areas including biological engineering, filtration, lightweight/strong composite materials, photovoltaics and energy storage. Illustrative and non-limiting examples of graphene applications include solar cells, light-emitting diodes (LED), touch panels, and smart windows or phones.

Hydrogen has many commercial uses, such as a clean and environmentally friendly alternative to fuel in internal combustion engines. Conventional methods of producing hydrogen from fossil fuels, however, produce carbon dioxide (natural gas steam reforming and coal gasification), which is harmful to the environment. Hydrocarbon decomposition, especially methane decomposition, has been recently investigated as an alternative way of commercial steam reforming process to produce hydrogen. Fe-based catalysts are often used for methane decomposition, because of their lower price and higher operation temperature than Ni-based catalysts. Methane decomposition reaction is an endothermic reaction, and thus higher reaction temperature can result in better activity.

US20080210908 (A1) claims a series of Fe-based catalysts for producing a hydrogen enriched fuel and carbon nanotubes from methane gas decomposition wherein the catalysts comprise a compound selected from the group consisting of FeAl; Fe₃Al, Fe₂CuAl, Fe₂NiAl, and Fe₂O₃/MgO. The corresponding process uses microwave-assisted methane decomposition on the claimed catalyst.

WO2008047321 (A1) claims a hydrogen production method by direct decomposition of natural gas and LPG, characterized in that a nickel-iron catalyst prepared by means of a multi-step adsorption approach on gamma-aluminium oxide is used.

US2016/0129423 (A1) claims supported fused Fe/Al₂O₃ catalysts with Fe loading of 5-65 wt % for hydrocarbon decomposition.

US2013/0224106 (A1) claims a method of selectively producing hydrogen or ethane from methane comprising selecting a temperature suitable for a metal catalyst and a feed gas including methane to produce a product having a controlled hydrogen/ethane ratio, predominately hydrogen and a solid carbon product or predominately ethane and hydrogen; contacting the feed gas with the metal catalyst at the selected temperature to produce the product. This method is limited to metal catalysts based on elemental iron; there is no disclosure of any catalyst based on iron ore.

A significant shortcoming of these catalysts is that they are very costly to prepare, which is the main reason why methane decomposition has not yet reached an industrial stage.

There are also a series of precious metals and carbon-based catalysts which have been described as suitable for the methane decomposition. Again, it has not been exploited commercially for a number of economic reasons. This primarily relates to the underlying catalyst costs, both in the initial supply, as well as costs in recycling and regenerating the catalyst. The vast majority of researchers in this area have utilized expensive and complex supported catalysts which, despite their high catalyst activity and product yield, result in extremely high catalyst turnover costs. These costs are a significant barrier to commercializing the use of such catalysts.

Patent application WO2016154666 (A1) claims a process for producing hydrogen and graphitic carbon from a hydrocarbon gas comprising: contacting at a temperature between 600° C. and 1000° C. the catalyst with the hydrocarbon gas to catalytically convert at least a portion of the hydrocarbon gas to hydrogen and graphitic carbon, wherein the catalyst is a low grade iron oxide. This process includes major drawbacks, including inter alia the production of carbon oxides during the decomposition process. Additionally, the hydrocarbon gas is only converted to graphitic carbon; graphene is not mentioned in WO2016154666.

There is thus still a demand for producing industrially hydrogen and graphene from hydrocarbons in a process which is efficient and commercially valuable.

The preceding discussion of the background art is intended to facilitate an understanding of the present invention only. It should be appreciated that the discussion is not an acknowledgement or admission that any of the material referred to was part of the common general knowledge as at the priority date of the present application.

### SUMMARY

In general, embodiments of the present disclosure describe a treated iron ore catalyst, methods of preparing a treated iron ore catalyst, and methods of using a treated iron ore catalyst to produce hydrogen and graphene.

Accordingly, embodiments of the present disclosure describe a treated iron ore catalyst.

Embodiments of the present disclosure further describe a method of preparing a treated iron ore catalyst comprising dehydrating iron ore, milling iron ore to a selected particle size, and reducing the iron ore to form a treated iron ore catalyst.

Another embodiment of the present disclosure is a method of using a treated iron ore catalyst comprising contacting a feed gas with a treated iron ore catalyst to produce hydrogen and graphene.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of preparing a treated iron ore catalyst, according to one or more embodiments of the present disclosure.

FIG. 2 is a flowchart of a method of using a treated iron ore catalyst, according to one or more embodiments of the present disclosure.

FIG. 3 is a graphical view showing methane conversion activity over time, according to one or more embodiments of the present disclosure.

FIGS. 4A-D are TEM images of carbon by-products over spent iron ore sample after catalytic methane decomposition in FIG. 3, according to one or more embodiments of the present disclosure.

FIG. 5 is a graphical view of X-ray powder diffraction spectra for untreated iron ore, according to one or more embodiments of the present disclosure.

FIG. 6 is a graphical view of X-ray powder diffraction spectra for a treated iron ore catalyst, according to one or more embodiments of the present disclosure.

### DETAILED DESCRIPTION

The invention of the present disclosure relates to novel treated iron ore catalysts. In particular, the invention of the present disclosure relates to treated iron ore catalysts, methods of preparing a treated iron ore catalyst, and methods of using a treated iron ore catalyst. The treated iron ore catalysts of the present disclosure may be contacted with a feed gas (e.g., hydrocarbons) to produce and/or coproduce hydrogen and graphene. At least one benefit of the present invention is that raw or naturally occurring iron ore may be treated according to the methods of the present disclosure to prepare a treated iron ore catalyst from an abundant natural resource. In addition, at least one other benefit of the present invention is that the methods disclosed herein may remove alkali oxides from the raw or naturally occurring iron ore and, more importantly, form treated iron ore catalysts with enhanced BET surface areas. Further, at least another benefit is that the formation of graphene and other forms of carbon may be controlled to prevent irreversible encapsulation of the active iron catalyst. These methods of preparing a treated iron ore catalyst provide an economically feasible route for the production of stable and effective catalysts with long lifetimes for use in the coproduction of hydrogen and graphene via, for example, catalytic methane decomposition (CMD) that may be regenerated at low costs.

### Definitions

The terms recited below have been defined as described below. All other terms and phrases in this disclosure shall be construed according to their ordinary meaning as understood by one of skill in the art.

As used herein, “contacting” refers to the act of touching, making contact, or of bringing to immediate or close proximity, including at the cellular or molecular level, for example, to bring about a physiological reaction, a chemical reaction, or a physical change.

As used herein, “dehydrating” and “dehydration” refers to reducing a content of water (e.g., water as a vapor, gas, solid, etc.).

As used herein, “graphene” refers to an allotrope of carbon in the form of a two-dimensional, atomic-scale, hexagonal lattice in which one atom forms each vertex. It is the basic structural element of other allotropes, including graphite, charcoal, carbon nanotubes and fullerenes.

As used herein, “iron ore” refers to untreated iron ore. In many embodiments, iron ore refers to raw or naturally occurring iron ore.

As used herein, “milling” refers to grinding, crushing, breaking, cutting, smashing, chopping, cracking, and any other technique known in the art.

As used herein, “treated iron ore catalyst” refers to a catalyst formed from iron ore according to any of the methods described herein.

Embodiments of the present disclosure describe a composition comprising a treated iron ore catalyst. As described in greater detail below, the treated iron ore catalyst may be prepared by performing steps that include, among others, at least dehydrating iron ore (e.g., raw or naturally occurring iron ore), milling iron ore to a selected particle size, and reducing the iron ore to form a treated iron ore catalyst. As also described in greater detail below, the treated iron ore catalyst may be used to produce and/or coproduce hydrogen and graphene by contacting a feed gas (e.g., a hydrocarbon gas) with the treated iron ore catalyst. It is a combination of the characteristics of the iron ore before treatment and the characteristics of the iron ore after treatment (e.g., the treated iron ore catalyst) that contributes to the formation of a catalyst that can produce and/or coproduce hydrogen and graphene via, for example, hydrogen decomposition. The catalyst formed (e.g., the treated iron ore catalyst) is advantageous over conventional catalysts because the treated iron ore catalyst is a high activity catalyst with a long lifetime suitable for application in industrial processes.

In general, raw or naturally occurring iron ore includes rocks and minerals from which metallic iron may be extracted. Iron ores are typically rich in iron oxides and vary in color from dark grey, bright yellow, or deep purpose to rusty red. The iron itself is typically found in the form of magnetite (Fe₃O₄, 72.4% Fe), hematite (Fe₂O₃, 69.9% Fe), goethite (FeO(OH), 62.9% Fe), limonite (FeO(OH).n(H₂O)) or siderite (FeCO₃, 48.2% Fe). By the loading of Fe, iron ores can be separated by high (>65% Fe loading), medium (62-65% Fe loading) and low (<62% Fe loading) grades. The impurities of iron ore samples can be SiO₂, Al₂O₃ and Loss on Ignition (LOI) in majority, while CaO, MgO, Na₂O, K₂O, TiO₂, and MnO may also exist in considerably negligible amounts. In addition, the total concentration of SiO₂ and Al₂O₃ can be as high as 50% by weight, and the concentration of LOI can be as high as 10% by weight. It is the total LOI, SiO₂, Al₂O₃, and iron oxides contents in the iron ore catalysts that not only provide the oxygen source to form carbon oxides during hydrocarbon decomposition (e.g., Catalytic Methane Decomposition (CMD)), but also makes it impossible to produce graphene. The invention of the present disclosure thus achieves an effective catalyst for the production and/or coproduction of graphene and hydrogen that is superior to conventional catalysts by treating the iron ore to control the content of iron, iron oxides, and impurities in the treated iron ore catalyst. In particular, the invention of the present disclosure controls the content of iron, iron oxides, and impurities in the treated iron ore catalyst to produce hydrogen without contamination of carbon oxide(s), while also producing high-value graphene and other carbon-containing products such as carbon nano materials, including, but not limited to, carbon nanotubes and carbon nano onions.

The treated iron ore catalyst may be characterized by the iron oxide content of the iron ore from which the treated iron ore catalyst is prepared. For example, the iron oxide content may range from about 80% by weight to about 100% by weight. The iron ore may include an iron oxide content of at least about 80% by weight. In a preferred embodiment, the iron oxide content is at least about 85% by weight. For example, in some embodiments, the iron oxide content is at least about 90% by weight.

The treated iron ore catalyst may also be characterized by one or more of an iron content, an iron oxides content, and an impurities content. In many embodiments, the iron content may be at least about 60% by weight, the iron oxides content may less than about 30% by weight, and the impurities content may be less than about 12% by weight, wherein the impurities may include one or more of SiO₂, Al₂O₃, CaO, MgO, Na₂O, K₂O, TiO₂, and MnO.

The iron content may be at least about 60% by weight. In some embodiments, the iron content may at least about 65% by weight. In other embodiments, the iron content may be at least about 70% by weight.

The iron oxides content may be less than about 30% by weight. In some embodiments, the iron oxides content may be less than about 28% by weight. In other embodiments, the iron oxides content may be between about 5% by weight and about 25% by weight.

The impurities content may be less than about 12% by weight, wherein the impurities include one or more of SiO₂, Al₂O₃, CaO, MgO, Na₂O, K₂O, TiO₂, and MnO. In some embodiments, the silica content may be less than about 7% by weight. In other embodiments, the silica content may be less than about 1% by weight. In some embodiments, the alumina content may be less than about 4% by weight. In other embodiments, the alumina content may be less than about 1% by weight. In some embodiments, the Loss on Ignition (LOI) content may be less than about 5% by weight. In other embodiments, the LOI content may be less than about 1% by weight. In another embodiment, the LOI content may be less than about 0.5% by weight.

The treated iron ore catalyst may further be characterized by comparing the content of iron, iron oxides, and impurities in the treated iron ore catalyst to the content of iron, iron oxides, and impurities in the iron ore from which the treated iron ore catalyst is prepared. In embodiments in which the treated iron ore catalyst is characterized in this way, any combination of the embodiments discussed herein relating to one or more of the iron oxide content, Loss on Ignition content, SiO₂ content, and Al₂O₃ content may be used to characterize the treated iron ore catalyst. In other embodiments, the treated iron ore catalyst may be characterized according to any of the descriptions provided herein. For example, the treated iron ore catalyst may be characterized according to one or more of the iron, iron oxide, and impurity content of the iron ore from which the iron ore catalyst is prepared; the iron, iron oxide, and impurity content of the treated iron ore catalyst; and the iron, iron oxide, and impurity content of the treated iron ore catalyst relative to the iron, iron oxide, and impurity content of the iron ore from which the treated iron ore catalyst is prepared.

In some embodiments, the treated iron ore catalyst may include an iron oxide content that is at least about 50% by weight lower than the iron oxide content of the iron ore from which the treated iron ore catalyst is prepared. In a preferred embodiment, the treated iron ore catalyst may include an iron oxide content that is at least about 60% by weight lower than the iron oxide content of the iron ore from which the treated iron ore catalyst is prepared. In a most preferred embodiment, the treated iron ore catalyst may include an iron oxide content that is at least about 70% by weight lower than the iron oxide content of the iron ore from which the treated iron ore catalyst is prepared.

In some embodiments, the treated iron ore catalyst may include a Loss on Ignition (LOI) content that is at least about 5% by weight lower than the LOI content of the iron ore from which the treated iron ore catalyst is prepared. In a preferred embodiment, the treated iron ore catalyst may include a Loss on Ignition (LOI) content that is at least about 50% by weight lower than the LOI content of the iron ore from which the treated iron ore catalyst is prepared. In a most preferred embodiment, the treated iron ore catalyst may include a Loss on Ignition (LOI) content that is at least about 90% by weight lower than the LOI content of the iron ore from which the treated iron ore catalyst is prepared.

In some embodiments, the treated iron ore catalyst may include a SiO₂ content that is at least about 0.5% by weight lower than the SiO₂ content of the iron ore from which the treated iron ore catalyst is prepared. In a preferred embodiment, the treated iron ore catalyst may include a SiO₂ content that is at least about 1% by weight lower than the SiO₂ content of the iron ore from which the treated iron ore catalyst is prepared. In a most preferred embodiment, the treated iron ore catalyst may include a SiO₂ content that is at least about 1.5% by weight lower than the SiO₂ content of the iron ore from which the treated iron ore catalyst is prepared.

In some embodiments, the treated iron ore catalyst may include an Al₂O₃ content that is at least about 1% by weight lower than the Al₂O₃ content of the iron ore from which the treated iron ore catalyst is prepared. In a preferred embodiment, the treated iron ore catalyst may include an Al₂O₃ content that is at least about 2% by weight lower than the Al₂O₃ content of the iron ore from which the treated iron ore catalyst is prepared. In a most preferred embodiment, the treated iron ore catalyst may include an Al₂O₃ content that is at least about 3% by weight lower than the Al₂O₃ content of the iron ore from which the treated iron ore catalyst is prepared.

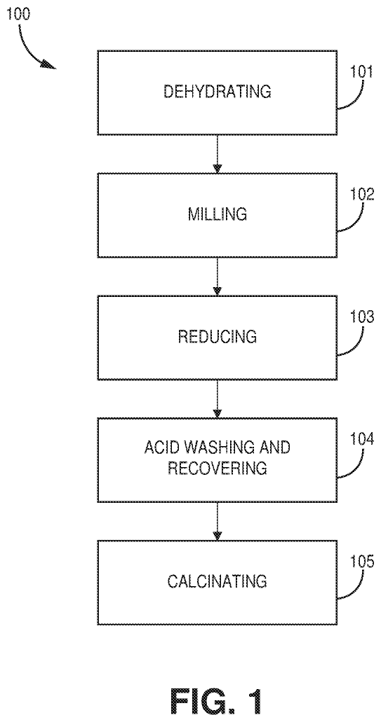

FIG. 1 is a flowchart of a method 100 of preparing a treated iron ore catalyst, according to one or more embodiments of the present disclosure. The method of preparing a treated iron ore catalyst includes dehydrating 101 an iron ore, milling 102 the iron ore to a selected particle size, and reducing 103 the iron ore to form a treated iron ore catalyst. The method of preparing a treated iron ore catalyst may optionally further include one or more of removing water while reducing 103 the iron ore, acid washing 104 the iron ore and recovering 104 a treated iron ore catalyst from a precipitate, and calcinating 105 the iron ore. Each of steps 102, 104, and 105 may be performed either before or after the dehydrating step 101. In addition, step 105 may be performed before or after the milling step. In preferred embodiments, each of steps 102 and 104 are performed before the dehydrating step 101. In a preferred embodiment, step 105 is performed after the dehydrating step. In a preferred embodiment, step 105 is performed before the milling step. The order described above, however, is illustrative and non-limiting as any order of steps may be used to form the treated iron ore catalyst.

At step 101, iron ore may be dehydrated. Dehydrating may include heating iron ore via any source of heat and using any conventional method. In general, dehydrating iron ore may include heating the iron ore to a temperature of at least about 100° C. to about 300° C. In many embodiments, dehydrating iron ore includes heating the iron ore to a temperature of at least about 100° C. for at least about 12 hours. In a preferred embodiment, the iron ore is heated at a temperature of at least about 100° C. for at least about 18 hours. For example, the iron ore may be heated at a temperature of at least about 100° C. for at least about 24 hours.

At step 102, iron ore may be milled to a selected particle size Milling may include one or more of grinding, crushing, breaking, cutting, smashing, chopping, cracking, and any other technique known in the art. In a preferred embodiment, the milling step is performed after the dehydrating step. In other embodiments, the milling step is performed before the dehydrating step. In many embodiments, the selected particle size is less than about 500 μm. For example, in some embodiments, the selected particle size is less than about 350 μm. In other embodiments, the selected particular size may range from about 10 μm to about 500 μm.

At step 103, the iron ore is reduced to form a treated iron ore catalyst. Reducing may include reducing an iron oxide content of the iron ore. For example, reducing may include reducing under a reducing atmosphere to decrease an iron oxide content of the iron ore. In some embodiments, reducing may include contacting the iron ore with a hydrogen-containing gas. The contacting between the iron ore and hydrogen-containing gas may occur for a period of about 30 minutes at a specified temperature. In some embodiments, the temperature may range from about 350° C. to about 900° C. For example, the temperature may include a temperature of at least 350° C. In some embodiments, the amount of hydrogen present in the hydrogen-containing gas may range from about 50% by weight to about 100% by weight. For example, the amount of hydrogen present in the hydrogen-containing gas may include at least about 50% by weight. In other embodiments, the amount of hydrogen may include at least about 75% by weight. In another embodiment, the amount of hydrogen may include at least about 90% by weight. In some embodiments, step 103 may further include, as an optional step, simultaneously removing water produced while reducing the iron ore.

An optional step 104 may include acid washing the iron ore and recovering a treated iron ore catalyst from a precipitate. In a preferred embodiment, step 104 is performed before the dehydrating step. In other embodiments, step 104 is performed after the dehydrating step. In some embodiments, this step may include providing iron ore to water (e.g., deionized water) and stirring to form a slurry and then a HCl solution (e.g., about 35% by weight of HCl) may be added thereto. The resulting solution may be boiled for a period of time (e.g., about 25 minutes) and diluted with water. An ammonia solution may then be slowly added until the pH reaches about 8. The solution may be heated (e.g., about 50° C.) for a period of time (e.g., about 10 minutes), during which a precipitate precipitates out of solution. The precipitate may be separated via filtration and washed (e.g., washed about 3 times) with deionized water at room temperature to recover the treated iron ore catalyst. In some embodiments, the treated iron ore catalyst is air-dried for a period of time (e.g., overnight) at about 110° C. The above is an illustrative and non-limiting example of step 104, but any technique known in the art may be used at step 104.

An optional step 105 may include calcinating iron ore. In some embodiments, this step may include contacting iron ore with an oxygen-containing gas. The contacting between the iron ore and oxygen-containing gas may occur for a period of time (e.g., at least about 30 minutes) at a select temperature (e.g., at least about 350° C.). In one embodiment, the oxygen-containing gas is air and the iron ore is calcinated in air at about 450° C. for about 2 hours.

Treating iron ore according to methods of the present disclosure (e.g., according to any of steps 101 to 105 in any order and in any combination) provides numerous benefits. For example, by treating iron ore in this way, the content of iron, iron oxide, LOI, silica, and alumina, among others, may be controlled. In addition, alkali oxides (e.g., Na₂O, K₂O, CaO, etc.) may be removed from the iron ore. Further, treating iron ore in this way increases and/or improves the BET surface area of the treated iron ore catalyst. In some embodiments, the treated iron ore catalyst observes an increase in BET surface area by a factor of at least 1.5 relative to the untreated iron ore. In a preferred embodiment, the BET surface area may increase by a factor of about 2 to about 10 relative to the untreated iron ore. By increasing the BET surface area, the hydrocarbon (e.g., methane) decomposition activity may significantly increase, for example, by reducing more iron out of iron oxides.

Any appropriate BET (m²/g) measurement method can advantageously be used in the present invention. For example, the BET (m²/g) can advantageously be measured by: Nitrogen adsorption-desorption isotherms of the iron ore samples by a Micromeritrics ASAP-2420 surface area and porosity analyzer instrument; before the measurement, the samples are degassed in vacuum at 300° C.; specific surface areas and adsorption-desorption isotherms are calculated according to Brunauer-Emmett-Teller (BET), and Barret-Joyner-Halenda (BJH) methods, respectively from the adsorption data.

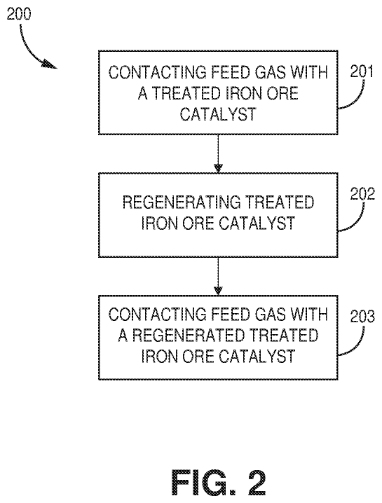

FIG. 2 is a flowchart of a method 200 of using a treated iron ore catalyst to produce and/or coproduce hydrogen and graphene, according to one or more embodiments of the present disclosure. The method of using a treated iron ore catalyst includes contacting 201 a feed gas with a treated iron ore catalyst, regenerating 202 the treated iron ore catalyst, and contacting 203 a feed gas with a regenerated treated iron ore catalyst. Steps 202 and 203 are optional.

At step 201, a treated iron ore catalyst is contacted with a feed gas to produce and/or coproduce hydrogen and graphene. In many embodiments, the treated iron ore catalyst may include and/or be prepared according to any of the compositions and methods described herein. In other embodiments, the treated iron ore catalyst may be substituted for an iron-based catalyst (e.g., not based on iron ore), which may be used to selectively produce a predominately hydrogen and solid carbon product or a predominately ethane and hydrogen product, such as those catalysts described in U.S. patent application Ser. No. 13/746,936, which is hereby incorporated by reference in its entirety.

In many embodiments, the feed gas is and/or includes hydrocarbons. In some embodiments, the hydrocarbons may be a hydrocarbon gas containing, for example, methane. For example, the feed gas may be one or more of natural gas, coal seam gas, landfill gas, and biogas. In some embodiments, the hydrocarbon gas may include light hydrocarbons. The light hydrocarbons may include one or more of methane, ethane, ethylene, propane, and butane. While in many embodiments the hydrocarbon gas includes light hydrocarbons as described above, the overall composition of the hydrocarbon gas may vary or may vary significantly with respect to components other than light hydrocarbons. In one embodiment, the hydrocarbon gas is natural gas. In another embodiment, the hydrocarbon gas is methane.

In one embodiment, the feed gas may include a hydrocarbon gas, wherein the hydrocarbon gas is a mixture of hydrogen and methane. A ratio of hydrogen to methane may be used to characterize the hydrocarbon gas. For example, in some embodiments, the molar ratio of hydrogen to methane (calculated as molar ratio of H₂/CH₄) may be between about 0.01 and about 4. In a preferred embodiment, the molar ratio of hydrogen to methane may be between about 0.05 and 0.5. For example, the molar ratio of hydrogen to methane may be between about 0.10 and 0.30.

The conditions (e.g., temperature and pressure) under which the treated iron ore catalyst is contacted with the feed gas may be selected to control and/or minimize the formation of carbon oxides during, for example, hydrocarbon decomposition. The control of carbon oxides formation during a hydrocarbon decomposition process is critical for the hydrogen industry (e.g., the fuel cell industry) because it is well known that said carbon oxides (e.g., especially CO) act as a poison to the very expensive catalysts used in the industry. By selecting the iron ore catalyst characteristics before and after treatment (e.g., reduction), the invention of the present disclosure provides a solution to these major drawbacks encountered in CMD. In addition, the invention of the present disclosure includes process operating conditions that permit control over and minimize the formation of carbon oxides during CMD.

The treated iron ore catalyst may be contacted with the feed gas at a select temperature to produce hydrogen and graphene from the feed gas (e.g., hydrocarbon). In many embodiments, thermal dynamics may require the reaction temperature to be higher than about 500° C. In these embodiments, a temperature of lower than about 500° C. may result in no conversion and a temperature greater than about 1000° C. may result in quickly deactivating the catalysts due to Fe particles agglomeration. In some embodiments, the select temperature is at least about 500° C. In a preferred embodiment, the temperature is at least about 700° C. In some embodiments, the temperature may be less than about 1000° C. In a preferred embodiment, the temperature is less than about 900° C.

The treated iron ore catalyst may also be contacted with the feed gas at a select pressure (e.g., under pressure) to produce hydrogen and graphene from the feed gas (e.g., hydrocarbon). In general, thermal dynamics may require a low pressure for methane decomposition. Performance improves as pressure is decreased. However, considering the proceeding pressure swing adsorption (PSA) membrane to separate H₂ from unconverted CH₄ gas, a slightly higher pressure—near ranging from about 8 bar to about 10 bar—may be more suitable for separations via the PSA membrane in some embodiments. For example, in many embodiments, the select pressure is at least about 1 bar. In a preferred embodiment, the select pressure is at least about 2 bars. For example, the select pressure may be at least about 4 bars. The select pressure may also be controlled such that it is less than about 10 bars. In a preferred embodiment, the select pressure is less than about 8 bars. For example, the select pressure may be less than about 6 bars.

The decomposition of the feed gas to produce hydrogen and graphene may be performed in a fixed bed reactor or a fluidized bed reactor. These reactors are illustrative and non-limiting as the decomposition may occur in any suitable environment known in the art.

The decomposition of the feed gas to produce hydrogen and graphene may also produce other carbon-containing products. The other carbon-containing products may include one or more of carbon nano onions (CNO) and carbon nanotubes (CNT).

A weight ratio of graphene to these other carbon-containing products may be used to characterize the decomposition of the feed gas (e.g., hydrocarbons). In many embodiments, the ratio of graphene to other carbon-containing products may be at least 3% by weight. In a preferred embodiment, the ratio of graphene to other carbon-containing products may be greater than about 5% by weight. In a preferred embodiment, the ratio of graphene to other carbon-containing products may be greater than about 10% by weight. In a preferred embodiment, the ratio of graphene to other carbon-containing products may be greater than about 15% by weight. In a preferred embodiment, the ratio of graphene to other carbon-containing products may be greater than about 20% by weight.

The formation of graphene as described herein and control over the formation of the other carbon-containing products may prevent and/or prevents the irreversible encapsulation of active iron in the catalyst. For instance, conventional methods of catalytic methane decomposition over untreated iron ores exhibit rapid deactivation of the catalyst—i.e., irreversible encapsulation of active iron by the other carbon-containing products. This is a clear indication that graphene is not produced as described herein. Transmission electron microscopy clearly demonstrates this.

An optional step 202 may include regenerating the treated iron ore catalyst. Following use of the treated iron ore catalyst for the production and/or coproduction of hydrogen and graphene, the treated iron ore catalyst may be regenerated via an oxidation treatment under an oxidizing atmosphere to recover carbon monoxide and a regenerated treated iron ore catalyst. The oxidation treatment may include contacting the treated iron ore catalyst with an oxygen-containing gas for a period of time (e.g., at least about 30 minutes) at a specified temperature (e.g., at least about 700° C.). In one embodiment, the oxygen-containing gas is air.

An additional option step (not shown in FIG. 2) may include reducing the treated iron ore catalyst to produce a regenerated treated iron ore catalyst. This step may be performed after optional step 202 and before optional step 203. Reducing may include contacting a treated iron ore catalyst with a hydrogen-containing gas for a period of time (e.g., at least about 30 minutes) at a select temperature (e.g., at least about 350° C.). In some embodiments, hydrogen may comprise more than about 50% by weight of the hydrogen-containing gas. In other embodiments, hydrogen may comprise more than about 75% by weight of the hydrogen-containing gas. In another embodiment, hydrogen may comprise more than about 90% by weight of the hydrogen-containing gas.

An optional step 203 may include contacting a feed gas with a regenerated treated iron ore catalyst. Step 203 may be performed according to any of the methods described herein. For example, the regenerated treated iron ore catalyst may be contacted with a feed gas (e.g., hydrocarbon gas) to produce and/or coproduce hydrogen and graphene.

Embodiments of the present disclosure further describe a method of regenerating a spent treated iron ore catalyst. The method of regenerating a treated iron ore catalyst may include reducing a spent treated iron ore catalyst. Reducing may include contacting a spent treated iron ore catalyst with a hydrogen-containing gas for a period of time (e.g., at least about 30 minutes) at a select temperature (e.g., at least about 350° C.). In some embodiments, hydrogen may comprise more than about 50% by weight of the hydrogen-containing gas. In other embodiments, hydrogen may comprise more than about 75% by weight of the hydrogen-containing gas. In another embodiment, hydrogen may comprise more than about 90% by weight of the hydrogen-containing gas.

Embodiments of the present disclosure may also describe a method of using a regenerated treated iron ore catalyst comprising contacting a feed gas (e.g., hydrocarbon gas) with the regenerated treated iron ore catalyst to produce and/or coproduce hydrogen and graphene. The regenerated treated iron ore catalyst may be prepared according to any of the methods described herein.

The present application describes various technical characteristics and other advantages with reference to the examples and/or various embodiments disclosed herein. Those skilled in the art will appreciate that the technical features of a given embodiment may in fact be combined with features of another embodiment unless the inverse is explicitly mentioned or unless it is obvious that these features are incompatible or that this combination does not provide a solution to at least one of the technical problems mentioned in the present application. Furthermore, the technical characteristics described in one embodiment can be isolated from the other features of this mode unless the inverse is explicitly mentioned. Consequently, the present embodiments must be considered illustrative, but they can be modified in the range defined by the scope of the attached claims.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

Four different iron ores, Samples A, B, C and D, are used in the examples. Their original composition (before treatment) is given in Table 1.

Each sample was, after wash/precipitation/dehydration process as described herein and above, calcined at about 500° C. for about 12 hours and then grounded and shaped into a 200-300 μm iron ore size range.

The calcined and milled iron ore was then subjected to a H₂ reduction at 750° C. for about two hours.

The composition of the treated Samples A, B, C and D is given in Table 2.

TABLE 1
original iron ore samples composition

| | Composition wt % | | | | | | | | | |
|---|---|---|---|---|---|---|---|---|---|---|
| Sample | Fe₂O₃ | Al₂O₃ | SiO₂ | CaO | MgO | TiO₂ | Na₂O | K₂O | LOI | MnO |
| A | 96 | 0.15 | 0.84 | 0.43 | 0.45 | 0.17 | 0.82 | 0.04 | 1.03 | 0.07 |
| B | 87 | 2.29 | 5.2 | 1.26 | 0.86 | 0.11 | 0.12 | 0.12 | 3 | 0.04 |
| C | 52 | 43 | 0.84 | 1.01 | 0.56 | 0.02 | 0.23 | 0.32 | 2 | 0.02 |
| D | 47 | 11.5 | 38.0 | 0.92 | 0.21 | 0.01 | 0.41 | 0.43 | 1.5 | 0.02 |

TABLE 2
sample composition after reduction treatment

| | Composition wt % | | | | |
|---|---|---|---|---|---|
| | | | | | CaO, MgO, TiO₂, Na₂O, |
| Sample | Fe | Fe₂O₃ | Al₂O₃ | SiO₂ | K₂O, LOI, MnO |
| A | 75 | 22 | 0.14 | 0.82 | <1% |
| B | 78 | 14 | 2.1 | 5.0 | <1% |
| C | 36 | 23 | 40 | 0.8 | <1% |
| D | 40 | 11 | 11.3 | 37.0 | <1% |

The BET surface area of the samples—before and after acid wash/precipitation/dehydration/calcination/milling treatments (before reduction)—is given in Table 3.

TABLE 3
BET

| | | After |
|---|---|---|
| sample | Before [m²/g] | treatment[m²/g] |
| A | 5 | 80 |
| B | 10 | 70 |
| C | 12 | 56 |
| D | 6 | 60 |

Catalytic methane decomposition (CMD) experiments were performed in a PID Microactivity fluidized bed reactor (FBR) equipped with quartz tube reactor with internal diameter 27 mm, and height 320 mm, and was heated by an electrical furnace, which is very stable at high temperatures. A horizontal quartz frit (distributor) with holes of 100 μm was used to divide the reactor into two chambers. All of the variables affecting the process, including pressure, temperature and gas flow rate, were recorded continuously by an on-line PC. The combined pressure drop across the distributor and the fluidized bed was measured with a Honeywell differential pressure transmitter. The reactor was heated to the desired reaction temperature using an electric furnace. Type K thermocouples were used for monitoring the reaction temperature (by placing the thermocouple into the quartz tube). Hydrogen, methane and nitrogen flow rates in the feeding gas were controlled by mass flow controllers (Bronkhorst).

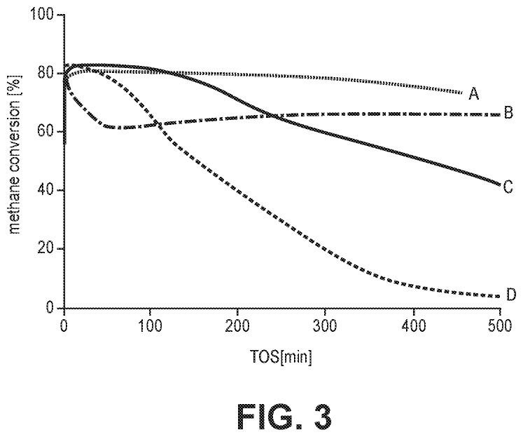

FIG. 3 is a graphical view showing methane conversion activity over time, according to one or more embodiments of the present disclosure. In particular, the CMD activity results over iron ore samples A, B, C and D is shown in FIG. 3. CMD conditions: fluidized bed reactor, 200-300 μm catalysts, 850° C., SV=1 L/g_{cat}·h.

It is clear that both iron ore samples C and D rapidly deactivated in term of methane conversion (A-B better than C-D). The morphologies of the formed carbon by-products is presented in FIG. 2.

On sample A, the carbon was found to be deposited as graphene layers. With increments of Al₂O₃ and/or SiO₂ concentrations inside the iron ore samples (as shown with samples C-D), carbon was deposited as carbon nano onions (CNOs) and/or carbon nano tubes (CNTs) to encapsulate Fe metal inside. The encapsulated metal Fe particles may become totally deactivated because of cutting-off contact with methane gas by the thick graphite layers. This explained the gradual deactivation of iron ore samples C and D during CMD in FIG. 3.

The formation of CO was also monitored by GC. For sample A, negligible CO was formed during the CMD. However, for iron ore samples C/D, CO in concentration ranged from 200 to 400 ppm was still detected even after 2 h CMD operation.

As shown and extracted from the table 4 experiments results, H₂ controlled addition to reactant methane gas was found to increase the H₂ productivity when the H₂ concentration was lower than 20%. Further increasing the H₂ amount in the reactant gas lowered the CMD reactivity.

As shown and extracted from the table 6 experiments results, reactor pressure control was found to increase the H₂ productivity when the pressure was increased up to 5 bars.

Moreover, a regeneration method was performed by flowing the air to spent CMD iron ore samples to convert solid C to CO gas. The detail condition is presented in Table 5. The catalyst was totally recovered to initial CMD activity even after 6 times regeneration. Only CO was formed during the regeneration process. This process over high-grade iron ore can be an alternative for commercial methane steam reforming to produce H₂ and CO separately without CO₂ emission.

TABLE 4
H₂ addition effect over sample A
Pre-reduction: pure H₂, 750° C., 2 h
CMD condition: fluidized bed reactor, 200-300 μm catalysts,
850° C., SV = 1 L/g_{cat} · h

| Reactant gas composition | H₂ productivity (L − H₂/g_{cat}) |
|---|---|
| Pure CH₄ | 19.48 |
| H₂:CH₄ = 1:9 | 19.54 |
| H₂:CH₄ = 2:8 | 22.35 |
| H₂:CH₄ = 5:5 | 16.23 |
| H₂:CH₄ = 8:2 | 10.22 |

TABLE 5
H₂ productivity vs regeneration time on sample A
Pre-reduction: pure H₂, 750° C., 2 h
CMD condition: fluidized bed reactor, 200-300 μm catalysts,
850° C., SV = 1 L/g_{cat} · h
Regeneration condition: fluidized bed reactor,
850° C., air, SV = 0.3 L/g_{cat} · h

| Regeneration | 0 | 1 | 2 | 3 | 4 | 5 | 6 |
|---|---|---|---|---|---|---|---|
| H₂ productivity | 19.48 | 19.76 | 19.44 | 20.12 | 20.06 | 19.13 | 19.38 |
| L-H₂/g_{cat} | | | | | | | |
| CO productiviy | 9.74 | 9.88 | 9.73 | 9.90 | 10.03 | 9.56 | 9.69 |
| L-CO/g_{cat} | | | | | | | |

TABLE 6
H₂ productivity vs reactor pressure on sample A
Pre-reduction: pure H₂, 750 C., 2 h
CMD condition: fluidized bed reactor, 200-300 μm catalysts,
850 C., SV = 1 L/g_{cat} · h

| Sample | Pressure[bar] | H₂ productivity [L − H₂/g_{cat}] |
|---|---|---|
| A | 1 | 19.48 |
| A | 3 | 21.56 |
| A | 5 | 25.34 |

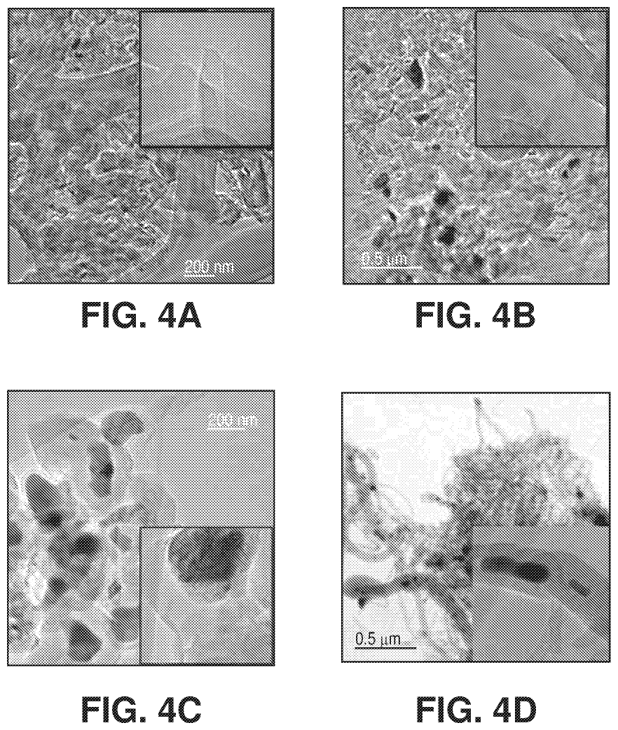

FIGS. 4A-D are TEM images of carbon by-products over spent iron ore sample after catalytic methane decomposition in FIG. 3, according to one or more embodiments of the present disclosure.

XRD analysis was performed on samples from Table 1 (untreated) and Table 2 (reduced). The crystalline structures of the iron ore samples were investigated by X-ray powder diffraction (XRD) patterns by BRUKER D8 Advance diffractometer using a monochromated CuKα radiation (λ=0.154 nm) in the 20 range from 10 to 80°. The counting step was 0.5° and the time per step was 0.52 s.

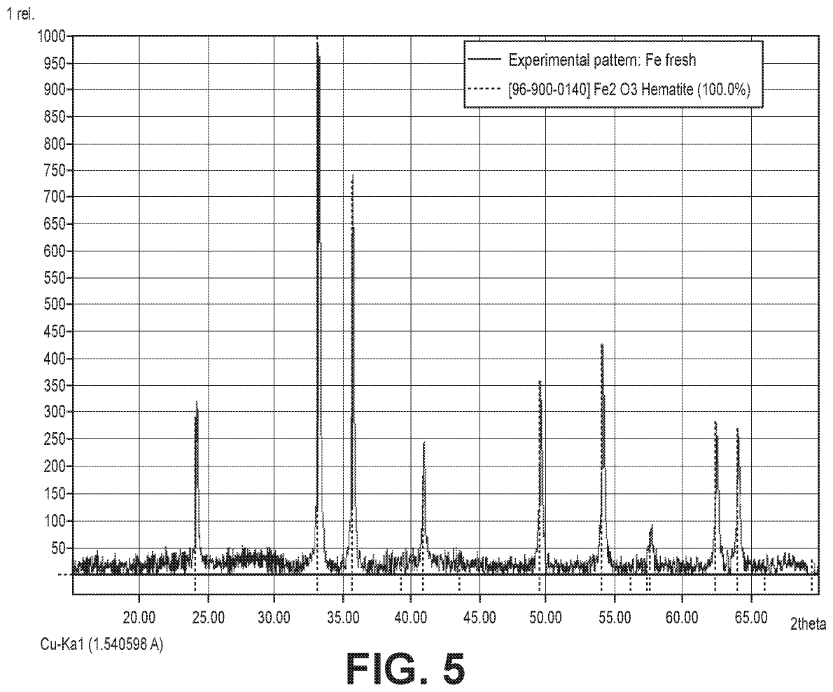

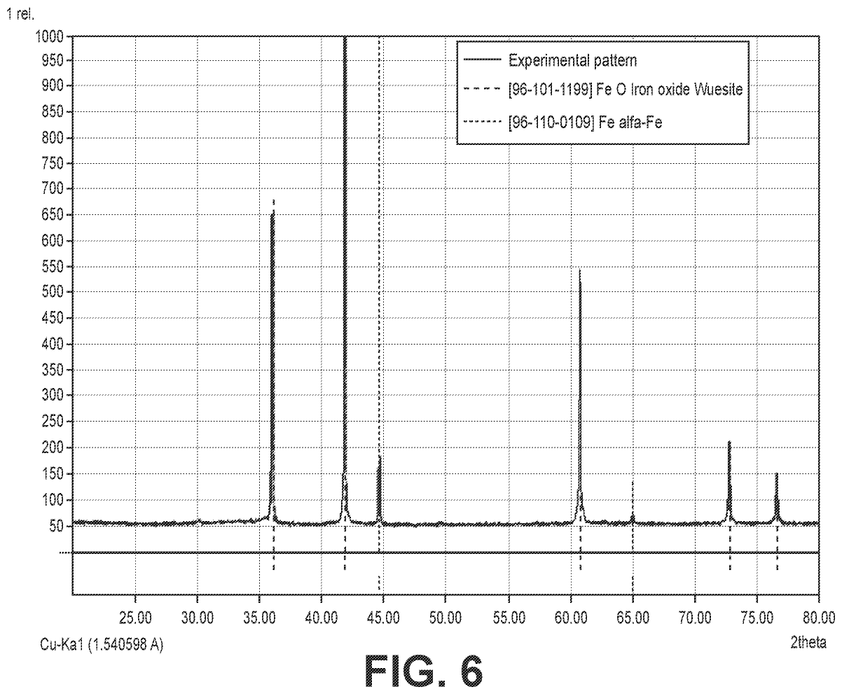

X-ray powder diffraction patterns for as received iron ore sample was representative of the pure hematite (Fe₂O₃) structure. The diffraction peaks of hematite at 2θ=24.2, 33.2, 35.65, 40.88, 54.2 were the main peaks which corresponded to the planes (0 1 2), (1 0 4), (1 1 0), (1 1 3), and (1 1 6) of Fe₂O₃, respectively. After reduction treatment, part of oxygen from Fe₂O₃ was removed to form FeO, part of which was further reduced to remove all the oxygen to form metallic Fe. This is shown in FIG. 5 (untreated) and FIG. 6 (treated).

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A composition, comprising a treated iron ore catalyst having an iron content of at least about 60% by weight and an iron oxides content of less than about 30% by weight.

2-3. (canceled)

4. The composition of claim 1, wherein an impurities content of the treated iron ore catalyst is less than about 12% by weight, wherein the impurities include one or more of SiO₂, Al₂O₃, CaO, MgO, Na₂O, K₂O, TiO₂, and MnO.

5. The composition of claim 1, wherein a silica content of the treated iron ore catalyst is less than about 7% by weight.

6. The composition of claim 1, wherein an alumina content of the treated iron ore catalyst is less than about 4% by weight.

7. The composition of claim 1, wherein a loss on ignition (LOI) content of the treated iron ore catalyst is less than about 1% by weight.

8. The composition of claim 1, wherein the treated iron ore catalyst is derived from untreated iron ore characterized by an iron oxide content of at least about 80% by weight.

9. A method of preparing a treated iron ore catalyst, comprising:
dehydrating an iron ore having an iron oxide content of at least about 80% by weight,
milling the iron ore to a selected particle size, and
contacting the iron ore with a hydrogen-containing gas to reduce the iron ore and form a treated iron ore catalyst having an iron content of at least about 60% by weight and an iron oxides content of less than about 30% by weight.

10. The method of claim 9, wherein dehydrating includes heating the iron ore to a temperature of at least about 100° C. for at least about 12 hours to about 24 hours.

11. The method of claim 9, wherein milling includes one or more of grinding, crushing, breaking, cutting, smashing, breaking, chopping, and cracking.

12. The method of claim 9, wherein the iron ore is reduced at a temperature of at least about 350° C.

13. The method of claim 12, wherein a concentration of hydrogen in the feed gas is at least about 50% by weight.

14. The method of claim 9, further comprising acid washing the iron ore and recovering a treated iron ore catalyst from a precipitate.

15. The method of claim 9, further comprising calcinating the iron ore.

16. A method of catalytic methane decomposition, comprising:
contacting a feed gas containing at least methane with a treated iron ore catalyst to produce hydrogen and graphene, wherein the treated iron ore catalyst comprises:
an iron content of at least about 60% by weight;
an iron oxides content of less than about 30% by weight.

17. (canceled)

18. The method of claim 16, wherein the feed gas is contacted with the treated iron ore catalyst at a temperature of at least about 500° C. and/or a pressure of at least about 1 bar.

19. The method of claim 16, wherein a ratio of graphene to other carbon-containing products is greater than about 3% by weight.

20. The method of claim 16, further comprising one or more of regenerating the treated iron ore catalyst and contacting the regenerated treated iron ore catalyst with the feed gas to produce hydrogen and graphene.
